(19) United States
(12) Patent Application Publication
(10) Pub. No.: US 2003/0084349 A1
(43) Pub. Date: May 1, 2003

(54) Early warning system for network attacks

(76) Inventors: Oliver Friedrichs, Menlo Park, CA (US); Elias Levy, San Francisco, CA (US); Alfred Huger, Calgary (CA); George Tomic, Calgary (CA)

Correspondence Address: FENWICK & WEST LLP, SILICON VALLEY CENTER, 801 CALIFORNIA STREET, MOUNTAIN VIEW, CA, 94041, US

(21) Appl. No.: 10/216,049

(22) Filed: Aug. 9, 2002

Related U.S. Application Data
(60) Provisional application No. 60/328,976, filed on Oct. 12, 2001.

(51) Int. Cl. G06F 11/30

(52) U.S. Cl. 713/201

(57) ABSTRACT

Security events based on network message traffic and other network security information are analyzed to identify validated security threats occurring on one or more networks. Alerts are prepared based on the results of the security analysis.

### CROSS-REFERENCED APPLICATIONS

This application claims priority under 35 U.S.C. §119(e) from U.S. Provisional Patent Application Serial No. 60/328,976, filed Oct. 12, 2001, the entirety of which is incorporated herein by reference.

### FIELD OF INVENTION

The present invention relates to tracking and predicting computer network security threats.

### BACKGROUND

Connecting computers and computer networks to general access networks, such as the Internet, offers many advantages. The ease of communication, availability of information, and potential commercial applications currently make Internet access indispensable for a wide variety of users. Unfortunately, usage of general access networks also exposes a user to risks. For example, any computer network connected to the Internet is barraged daily with thousands, if not millions of messages requesting some type of action by a processor on the network. While most of this network traffic is either beneficial or innocuous, even a single harmful communication can quickly damage stored data or disrupt efficient network operation.

A number of different classes of network security devices exist solely to protect the user from these threats. These security devices include intrusion detection systems, firewalls, anti-virus products, honeypots, and routers among others. Intrusion detection systems monitor network traffic looking for indications of attack. By denying access to certain types of messages, firewalls prevent many harmful communications from reaching a network. Anti-virus products detect known and occasionally unknown viruses entering a network. Honeypots provide bait for an attacker, allowing the detection of attackers targeting these bait systems. Routers process network packets, passing them from one network to another. While doing so they may serve the purpose of a firewall, and also provide network stability information.

One way to complement the security effects of these disparate network security devices is by tying together and analyzing the numbers and types of events recorded by these devices. Security devices routinely monitor network messages and other network traffic. As part of this monitoring function, the security device will typically create an event logfile that describes the network activity observed by the security device. The security events recorded in this logfile may describe a transmission or receipt of an individual message, or they may be a summary of a pattern of network activity. These event logs contain valuable data regarding potential security incidents, situations where the network operator should take additional actions in order to prevent or limit damage to the computer network. Due to the large amounts of data collected, the event logs are typically analyzed automatically by the security system that generated the event log.

Unfortunately, the information obtained by analyzing an individual system security event log tends to be isolated and reactive in nature. The event log analysis provides information about a possible security incident only after its inception on that particular network, and only for a single security device. This limits the ability of the network operator to use the log analysis to prevent damage to the network by taking appropriate action in response to the network messages or traffic causing the security incident. Additionally, even when one network operator identifies a security threat, operators of similar computer networks at other companies, or even at other offices within the same company, are unlikely to be aware of the danger. This problem is compounded by the variety of network security products currently on the market. Each network security product will typically have its own method and terminology for tracking security events, making it difficult to determine if two networks are encountering the same security threat. This can pose difficulties not only in transferring information between networks, but may even hamper security analysis within a single network when multiple security systems have been implemented.

What is needed is a way of aggregating information about network traffic regardless of how or where it is collected, analyzing the network traffic information to identify security threats at the earliest possible stage, and distributing this information in a timely manner in order to neutralize security threats, prior to any damaging activity, on as many networks as possible.

### SUMMARY

Some embodiments of the present invention enable the detection and analysis of network security threats by aggregating information regarding security events gathered from multiple information sources, both within a local network configuration and on a worldwide global scale. Once security event information has been gathered by a network security device or other suitable information source, the information can be uploaded to a processor capable of identifying potential security threats regardless of the initial source of the information. The security event data can then be correlated with security event data from other security devices and analyzed to identify security threats. This may include identifying security events corresponding to known viruses as well as evaluating the occurrence rate of otherwise innocuous events to find anomalies. This analysis and correlation can lead to the discovery of local and global security threats at an early stage.

Some embodiments of the present invention can also provide the capability to identify security threats affecting particular demographic and geographic regions. Demographic and geographic data regarding the owners or users of each network may be associated with each security device. This demographic and geographic data can be tracked during the analysis of security events so that demographic and geographic trends may be identified. This allows for determination of trends in security events, such as when security threats arise in connection with particular types of software, industries, states or countries. By aggregating data from more than one source, such trends can be detected early, allowing for warnings to be rapidly distributed to any potential targets of the security threat.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram illustrating an embodiment of the present invention for analysis of security events on a network.

FIG. 2 is a block diagram of an embodiment of the present invention for analysis of security events on multiple networks.

FIG. 3 is a flow chart illustrating the steps involved in processing network event activity data according to another embodiment of the present invention.

FIG. 4 depicts a database structure that may be used in conjunction with some embodiments of the present invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF PREFERRED EMBODIMENTS

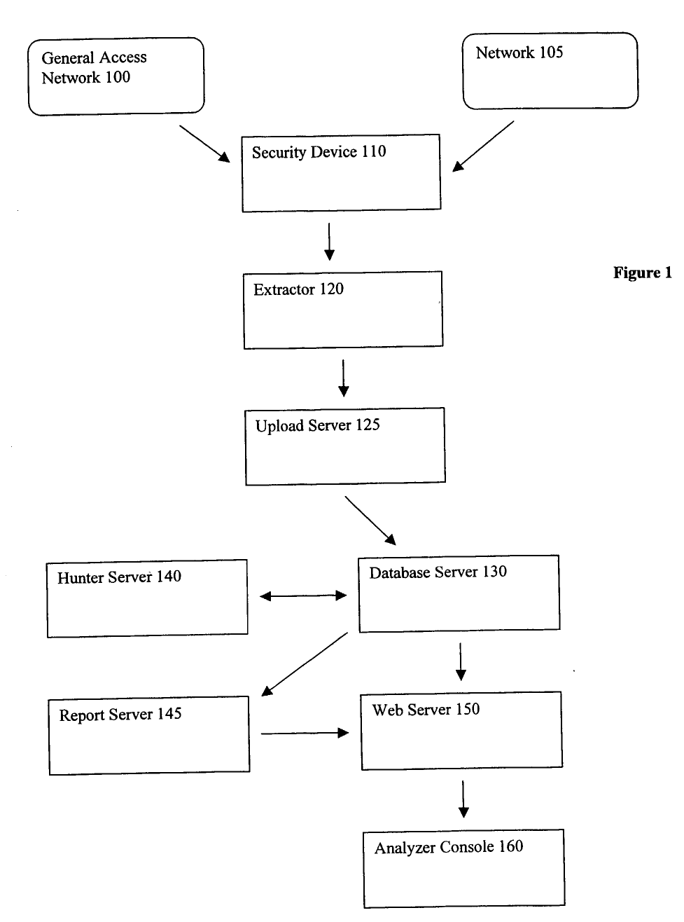

FIG. 1 illustrates a system for identification and analysis of security events occurring on a single network according to one embodiment of the present invention. Network 105 represents a local network, private network, or other type of network that might be connected to a general access network 100. General access network 100 may be any network that permits access by multiple individuals or groups. The Internet is a well-known example of a general access network 100. In another example, general access network 100 could be the main network of a university and network 105 could represent the local network of a building, academic department, or other grouping within the university. In yet another example, general access network 100 could be a proprietary network and network 105 could represent a customer using the proprietary network. Other examples will be apparent to those skilled in the art.

Security device 110 may be any system or sensor that tracks network messages (or other types of network traffic) that have entered or are attempting to enter network 105 from general access network 100, or which gathers other security relevant data. There are many current examples of security devices, such as firewalls, anti-virus programs, intrusion detection systems, or honeypots. Typically security device 110 will record security events in an event logfile. Due to the many types of security devices available and in commercial use, the format, terminology, and fields of information stored in the event logfile will vary. The event logfile may be a text file, a database file, or a file in another format.

Extractor 120 may obtain security events recorded by a security device 110 in a variety of ways. In some embodiments, security device 110 sends information gathered about security events as the information is collected. The information may be sent to extractor 120, for example, as an SNMP message or as a Syslog message. In other embodiments, extractor 120 obtains the contents of an event logfile generated by security device 110 and converts the event logfile entries into a common XML format without additional processing. In an embodiment, extractor 120 is a program running on a workstation that accesses an event logfile created by security device 110, identifies the format of the event logfile, and extracts desired fields of information about the security event from the event logfile. In an embodiment, these extracted fields are then written to a common XML format file. In an embodiment, each entry within this common XML format file includes 1) the source IP address of the event, 2) the source port of the event, 3) the destination IP address of the event, 4) the destination port of the event, 5) the protocol associated with the event, 6) the event name for the message, 7) event specific packet data, and 8) a timestamp for the message.

After collecting security event data from security device 110, extractor 120 passes the security event data to database server 130. In an embodiment, the security event data may be transferred to an upload server 125 before being passed to the database server. Alternatively, the security event data may be directly transferred to database server 130. In one embodiment, security event data may be transferred as an XML file. In another embodiment, security event data may be transferred using the SNMP protocol. Initially transferring the security event data to an upload server 125 allows for additional processing of the security event data prior to reaching database server 130. For example, in some embodiments upload server 125 may perform a security event analysis on the security event data to identify trends and events occurring among multiple security devices. Upload server 125 may also convert the security event data into an appropriate format for the databases located on database server 130. Additionally, upload server 125 may send process requests to hunter server 140 for identification of originating parties for security events. In yet another embodiment, extractor 120 may also add demographic and geographic information about the security device to the event data that is being sent to database server 130 or upload server 125.

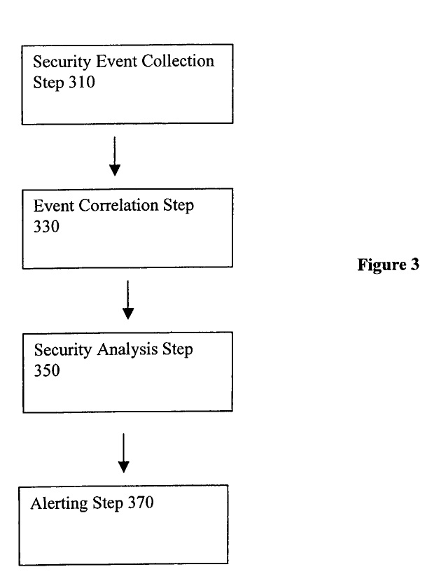

In still another embodiment, extractor 120 may also perform a security event analysis on the security event data and transmit only summary analysis information to the upload server, or alternatively, to the database server. The steps involved in analyzing the security events and identifying security threats will be discussed in greater detail below in connection with FIG. 3.

In one embodiment, upload server 125 is a workstation such as a Microsoft IIS web server. The web server can be configured to use SSL (Secure Socket Layer), and can contain a valid SSL security certificate. In some embodiments, in order to transfer data from extractor 120 to upload server 125, a user must log in to upload server 125 using a secure SSL connection. The user authenticates to upload server 125 via a previously generated account on the upload server. After authentication, the user uploads the security event data. This security event data is received by upload server 125 and stored as a unique file to await processing. In another embodiment, connection to upload server 125 and authentication is automatically done on a scheduled basis to allow for regular uploads of network event profiles. In yet another embodiment, security event data is received by the upload server as SNMP messages from extractor 120.

Hunter server 140 receives process requests for identification of participants in security events from either upload server 125 or database server 130. Security device 110 may only record limited information regarding the originating parties of a security event on the network, such as the network address and port for an originating party. Hunter server 140 uses this information to identify the actual participants. For example, in an embodiment where general access network 100 is the Internet, hunter server 140 may perform a reverse domain name lookup on the IP address of the originating party to identify the domain name service (DNS) name of the IP address. Hunter server 140 may also perform a WHOIS lookup on the IP address to determine the registered name of the owner of the IP address, the owner of the network domain name, contact information for the owner, and location information for the owner. The contact information for the owner may include regular mail, e-mail, and telephone contact information. Location information may include the country, state, or province of the owner. The information available in a WHOIS lookup may vary in part due to the variety of WHOIS servers currently in use. Currently available WHOIS servers include servers provided by Network Solutions, Inc., RIPENET, APNIC, ARIN, and KRNIC. Of course, the present invention is not limited to any specific WHOIS server. Hunter server 140 may also take advantage of other methods for obtaining identifying information regarding IP addresses, including information from commercial sources. Similarly, in embodiments involving other general access networks 100, alternative methods for identifying participants in security events may be used by hunter server 140. In one embodiment, hunter server 140 is a workstation running a computer program for carrying out the tasks listed above. In another embodiment, hunter server 140 is located on a server on a remote network, and receives requests from upload server 125 or database server 130 to obtain information regarding IP addresses. Remote hunter server 140 then processes said request, and returns gathered information to upload server 125 or database server 130.

Database server 130 receives security event data from either extractor 120 or upload server 125. After receiving the security event data, database server 130 converts the security event data into a common, vendor-independent format to allow for correlation of security events corresponding to the same security event type. In one embodiment, database server 130 directly converts the individual security events into equivalent security events recorded in the vendor-independent format. In another embodiment, the security event data may be directly converted to a common, vendor-independent format by extractor 120 or upload server 125. In still another embodiment, conversion of the security event data may comprise mapping the security events to a database that is composed of security event types in the common, vendor-independent format. Other methods of converting the security event data into a common, vendor-independent format will be apparent to those skilled in the art.

Security event data received by database server 130 is incorporated into a database such as All-Events database 410. Database server 130 may also supplement the security event data with associated demographic or geographic data regarding the network generating each security event. Database server 130 then runs queries on the security event data to analyze security events that occur on network 105 or general access network 100. In an embodiment, queries are run on event data collected from individual security devices. In another embodiment, queries are run on event data collected from multiple security devices that monitor one or more networks. As noted previously, in other embodiments upload server 125 or extractor 120 may perform some or all of the tasks involved in the security event analysis. The steps involved in analyzing security event data and identifying validated security threats will be discussed in greater detail below in connection with FIG. 3.

After the security event analysis, a portion of the security event analysis information is sent to report server 145. In one embodiment, report server 145 prepares reports regarding security events occurring on network 105. The reports may be customized based on settings selected by the owner of network 105. The reports may include a wide variety of information, such as the total number of security events, which security events are increasing in number, which ports on network processors are being attacked, or the geographic location of the originating party for a security event. In another embodiment, reports may include information such as common security events being observed by an increasing number of security devices, common countries that are attacking multiple security devices, or common IP addresses being observed by multiple security devices. In another embodiment, report server 145 prepares reports regarding security events occurring on general access network 100. In yet another embodiment, report server 145 prepares reports regarding validated security threats identified during the security event analysis. In still another embodiment, report server 145 prepares alerts for distribution to users. Reports generated by report server 145 are then passed to output web server 150 for user access. Reports may also be sent out to a user, via email, pager, FAX, or other delivery mechanisms.

Output web server 150 allows a user of analyzer console 160 to access security event information regarding network 105 or general access network 100. Output web server 150 receives reports from report server 145 as well as security event information from database server 130. In one embodiment, analyzer console 160 is a web page that displays information requested by users. This web page may contain reports, graphs of security event data, and other information related to the processing and analysis of security events and detection of security incidents. In another embodiment, user access involves authentication to verify the user's right to view the requested information. In still another embodiment, analyzer console 160 is a general purpose portable display device configured to receive security event information, such as a laptop computer, PDA, or cellular phone. Authorization may also be required in this embodiment. In one embodiment, a user may request specific reports to be run on event data. In another embodiment, a user is presented with set of reports outlining recent abnormal activity.

In yet another embodiment, output server 150 automatically prepares an e-mail or other form of electronic communication to notify the originating party of a security event of their participation in a security event. The contact information obtained by hunter server 140 may be used to automatically generate an e-mail with a description of how the originating party participated in the security event. This e-mail could be sent to the owner of the network generating the event, the owner of the network domain, or another appropriate party related to the source of the security event. In an embodiment, the user of analyzer console 160 is prompted for whether to send a notification to an originating party. In another embodiment, the user may modify the content of the e-mail prior to sending the communication to an originating party.

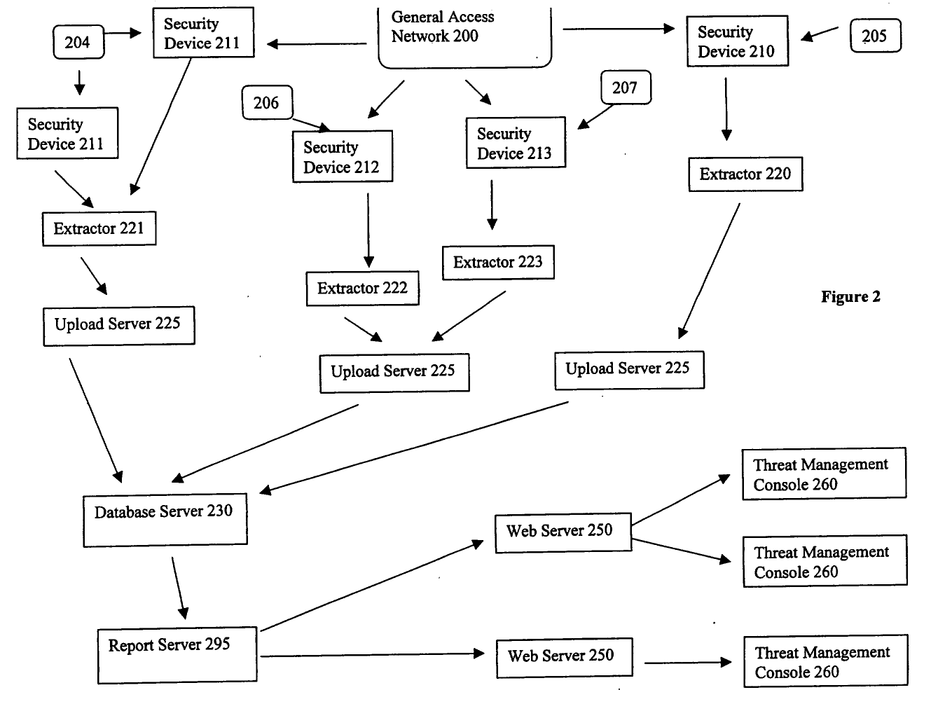

FIG. 2 depicts another embodiment of the invention, in which security devices monitoring multiple networks provide information to a common database server for identification and analysis of security events. In FIG. 2, networks 204, 205, 206, and 207 are depicted as having connections to a general access network 200. In alternative embodiments, however, networks 204-207 could be connected to multiple general access networks. In FIG. 2, security devices 210, 211, and 212 perform similar types of functions as security device 110 described above, but security devices 210-212 are shown in several configurations. Security devices 211 both monitor activity on a single network 204. This depicts the situation where a single network has more than one security device available. In one embodiment, extractor 221 obtains security event data from each security device 211 and creates separate files of security event data. In another embodiment, extractor 221 combines the collected security events from all security devices 211 to create one file of security event data for network 204. In yet another embodiment, extractor 221 performs a comparison of the security event data generated by all security devices 211. Extractor 221 then uses the comparison to identify security events that were recorded by both security devices and eliminate duplicate entries.

Security devices 212 and 213 track network activity on networks 206 and 207, respectively. Similarly, extractors 222 and 223 process security event data generated by security devices 212 and 213 respectively. Extractors 222 and 223 both transfer their files of security event data to database server 230 via a single upload server 225. The transfer of information between extractors 222 and 223 and upload server 225 may be performed at scheduled intervals, when sufficient information is present at an extractor, in real time, or in any other suitable manner.

Security event data processed by extractors 220-223 may then be correlated and analyzed. In an embodiment, extractors 220-223 pass information to database server 230 either directly or via upload servers 225. After receiving the security event data, database server 230 may directly convert the security event data into a common, vendor-independent format to allow for correlation of similar security events. In another embodiment, the security event data may be directly converted to a common, vendor-independent format by extractor 120 or upload server 125. In still another embodiment, converting the security event data comprises mapping the security events within the security event data to a listing of common, vendor-independent security event types. The security event data is then incorporated into a database such as All-Events database 410. Additionally, database server 230 may issue process requests to one or more hunter servers 240 in order to gather additional information regarding the source of individual security events. Database server 230 may also supplement each security event with associated demographic and geographic information regarding the network generating the security event. After these steps are complete, database server 230 may perform a security event analysis. The steps involved in analyzing security event data and identifying security threats will be discussed in greater detail below in connection with FIG. 3.

After the security event analysis, users are alerted to the results. In an embodiment, report server 295 receives results of the security event analysis and automatically prepares reports. These reports may be customized based on preferences selected by a user. The reports may also incorporate additional information provided by analysts. The reports are then transferred to web servers 250 for distribution to users. The reports may be sent to users via threat management consoles 260. Alternatively, users may receive the reports via e-mail or on a PDA or other portable display device. Users may also be given the option of notifying owners of the originating network for the security event. Additional methods of alerting users to the results of a security event analysis are discussed in greater detail below in connection with FIG. 3.

FIG. 3 depicts a flow chart for processing of security event data according to one embodiment of the present invention. In this embodiment, the security event information from one network is aggregated with security event information from other networks. In this embodiment, a user of the present invention would be able to obtain reports regarding security events occurring on the user's network, trends in security events occurring in other networks, and other security relevant data, such as network BGP data, and Distributed Denial of Service backscatter statistics.

The first step in this embodiment is Security Event Collection step 310. Security Event Collection step 310 comprises obtaining security event data for one or more networks. The collected security event data may then be aggregated with other previously collected security event data for analysis. In one embodiment, Security Event Collection step 310 comprises obtaining the security event data from one or more security devices. The security event data may be obtained by processing logfiles generated by the security devices. Alternatively, the security event data may be accumulated in real time as the security devices track network messages and other security events. In still another embodiment, obtaining the security event data comprises receiving security event data from another processing unit, such as a processing unit that has previously extracted security event data from a security device event logfile. In yet another embodiment, the security event data obtained by Security Event Collection step 310 is in the form of a summary of previously analyzed security events.

Security Event Collection step 310 may also include obtaining demographic and geographic information regarding the network providing security event data. In an embodiment, the demographic and geographic information for a network is stored ahead of time in a database. The stored demographic and geographic information can then be used to supplement the security event after it is collected. In another embodiment, security events are mapped to the database entry for the appropriate network. In yet another embodiment, demographic and geographic information may be provided by the security device recording the security event, such as by including the information as fields within the security event. Other examples of how to associate demographic and geographic information with a security event will be apparent to those skilled in the art.

Many types of information may be included in the demographic and geographic information associated with a security event. For example, the demographic information may include the type of network reporting the security event, the applications or operating systems in communication with the network, or the types of security measures implemented on the network. Other information may include data regarding the owner of the network, such as the geographic location, the size of the company (revenue or employees), the type of business engaged in by the owner, and the types of business functions the owner has implemented on the network. In some embodiments, the demographic information associated with a security event will not identify the owner of the network specifically. In an embodiment, any identifying information that references the particular network providing the security event data, such as the name of the network owner or the address of the network, is removed during the extraction phase. In another embodiment, identifying information referencing the particular network providing the security event data is excluded during the security analysis step.

The second step in this embodiment is Event Correlation step 330. Event Correlation step 330 comprises converting vendor specific security events to a common, vendor-independent event type. In some embodiments, this conversion comprises mapping vendor specific security events to a common, vendor-independent event type. In an embodiment this may be performed in a process separate from the initial extraction process. In another embodiment this may be performed during the extraction process. In an embodiment, this mapping is performed via a database that links vendor specific event types to a common event type. In another embodiment, the vendor specific security event is directly converted by rewriting the security event in the format of the corresponding common, vendor-independent event type. For different security device types different items are used to determine the correct conversion. For example, port numbers are much more relevant items to correlate than event names for security event data obtained from a firewall. By converting vendor specific security events to a common, vendor-independent event type, security events of similar types may be correlated in spite of the fact that the events are recorded in diverse, vendor specific formats. The correlation may occur between security events recorded by similar types of security devices, such as one or more Intrusion Detection Systems, or between different types of security devices, such as Firewalls, Intrusion Detection Systems, Honeypots, and Anti-virus products. This correlation may also include security event data obtained from other data sources, such as network BGP data and Distributed Denial of Service attack backscatter statistics. Other examples of security related data available from a network will be apparent to those skilled in the art.

After correlating the vendor specific security events with common, vendor-independent event types, the security event data undergoes a security event analysis during Security Analysis step 350. Security Analysis step 350 may comprise a variety of methods for performing a security event analysis. In some embodiments, Security Analysis step 350 comprises using statistical analysis to identify validated security threats based on the security event data. In these embodiments, the frequency of occurrence for a given type of security event is calculated. This frequency can then be compared to stored baseline values to determine if the frequency is sufficiently different from the baseline values to constitute a validated security threat. Alternatively, baseline values could be calculated as needed based on past security event data for a particular network or security event data from networks with similar demographic profiles. In some embodiments, statistical analysis can be performed to detect the following network activities, 1) an increasing number of systems that are being observed launching a particular event, 2) an increasing number of security devices detecting a particular event, 3) an increasing number of systems that are targeting a particular port, 4) an increasing number of security devices that are observing activity on a particular port, 5) individual security devices that are observing higher than normal occurrences of a particular event, 6) individual security devices that are observing higher than normal occurrences of activity on a particular port. In an embodiment, this type of calculation may also be performed for events originating from security devices in a particular demographic or geographic region.

In another embodiment, Security Analysis step 350 comprises identifying linked series of security events that indicate the presence of a validated security threat. In this embodiment, security events are analyzed to find specific sequences of event types occurring on a single network or on related networks. A sequence may be composed of a only a single security event type, or the sequence may be composed of multiple different security event types. In an embodiment, identification of the linked series may consist of detecting different security events occurring in a specific order. In another embodiment, identification of the linked series may consist of detecting different security events occurring in close temporal proximity independent of the sequence. Thus, identification of linked series of security events is a complement to the technique of looking for an increased frequency of events of a single event type and provides another way of detecting validated security threats where the individual security events do not indicate the true scope of the validated threat. In still other embodiments, Security Analysis step 350 comprises comparing security events with a database of known validated security threats. In an embodiment, Security Analysis step 350 and Event Correlation step 330 may take place concurrently.

The results of Security Analysis step 350 are delivered to users during Alerting step 370. Alerting step 370 may include notifying users of validated security threats and other results of a security analysis in a variety ways. For example, a user may be alerted by receiving a system generated report outlining security event activity that has led to the alert. This alert may contain graphs depicting relevant security event data, including how many security devices were affected, which countries the attacks originated from, and the top attackers. This report may be issued when an increase of activity towards a particular port is seen or when an increase of a particular event type is seen. The report may also be issued when a validated security threat is detected. The report may be industry specific or may cover all global activity. The report may be delivered via a number of mechanisms, including email, cell phone, pager, SMS or fax. In another embodiment, the alert report may be one that is created by analysts based on past activity, such as previously recorded security events, in combination with human intelligence. Human intelligence may be obtained in numerous ways, including personal relationships, observations of hacker activity, and monitoring of hacker chat rooms and message boards. Alerts may also be saved and stored on the web service for viewing in the future. In still other embodiments, Alerting step 370 may be performed by the maintenance of a Threat Level, a simple meter used to describe the current level of threat to a network 105, or to a general access network 100. In one embodiment, this meter can be a rating from 1 to 4 to indicate increasing levels of threat to a network 105 or a general access network 100. Computation of a Threat Level may include a variety of factors including frequency of occurrence of a particular threat, the potential damage to a network, or whether the threat is likely to attack a particular network based on previous demographic and geographic trends. Variations in a Threat Level may be delivered to the user automatically, through the previously mentioned delivery mechanisms, or it may be viewable through a web interface.

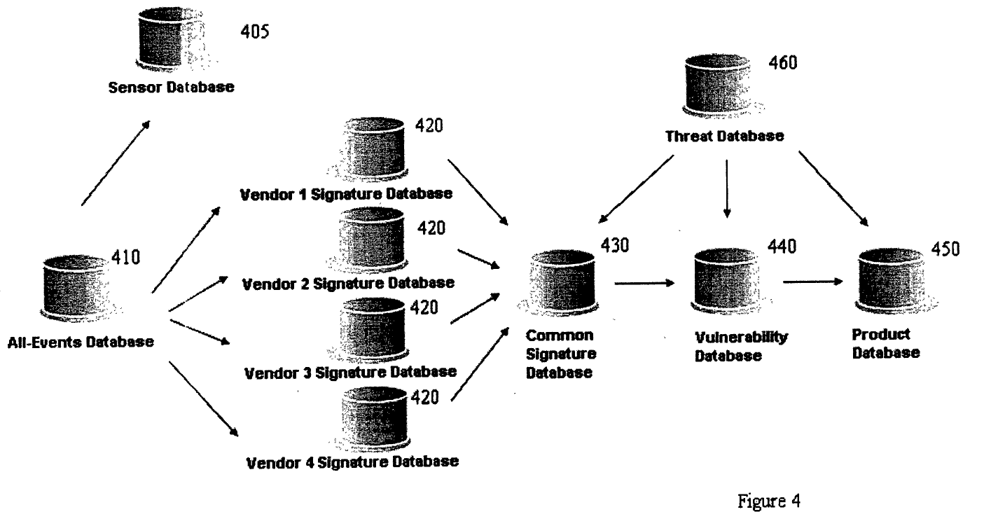

FIG. 4 provides a schematic of possible database structures that may be used with various embodiments of the present invention. In one embodiment, the databases shown in FIG. 4 are stored on a database server such as database server 130 in FIG. 1.

All-Events database 410 is a database that can contain all security events that have been uploaded to the database server. Thus, All-Events database 410 can contain every security event recorded by every security device participating in the system. These accumulated security events may then be analyzed for statistical anomalies or linked series of security events that indicate a validated threat. In an embodiment, the security events in All-Events database 410 are stored in a vendor specific format. In another embodiment, the security events in All-Events database 410 may be in a common, vendor-independent format.

Information about the security devices that upload security event information to All-Events database 410 is located in Sensors database 405. In addition to providing a list of all known security devices and their proprietary types, Sensors database 405 also contains demographic and geographic information about the location of the security device. In one embodiment, each time a security event is added to All-Events database 410, the security event data is supplemented with demographic and geographic information about the security device recording the event. Alternatively the security events in All-Events database 410 may be mapped or linked to the appropriate entry in Sensors database 405.

Vendor Signature databases 420 and Common Signature database 430 allow security events recorded in vendor specific format to be matched to a common, vendor-independent event type. Vendor Signature databases 420 contain information regarding vendor specific security event types. Due to the large number of security device vendors, many different formats are used to record security events. Vendor Signature databases 420 contain a listing of all known security event types for a particular vendor. In an embodiment, a separate Vendor Signature database 420 is maintained for each security device vendor. The entries in the Vendor Signature databases 420 are mapped to the corresponding entry in Common Signature database 430. Thus, many vendor specific security event types may be mapped to a single entry in the common signature database. When a security event in vendor specific format is added to All-Events database 410, Vendor Signature databases 420 are consulted and the security event is mapped to the matching vendor specific security event type. Typically the type of security device providing the security event will be known, so only one of the Vendor Signature databases 420 will need to be accessed to map a given security event. Because the entries in Vendor Signature database 420 are mapped to the common, vendor-independent security event types in Common Signature database 430, this creates a mapping between an individual security event and a corresponding vendor-independent security event type.

By compiling all recorded security events, associating the security events with demographic and geographic information, and mapping the events to common, vendor-independent event types, All-Events database 410 may be used to analyze security events based on a wide variety of characteristics. These characteristics include the type of security event, time of the event, location of the network, and type of network experiencing a security event for all security events recorded by each network that contribute security events to the database. The contents of All-Events database 410 can thus be used to identify demographic and geographic trends in security events as part of a security analysis. Many possible trends can be searched for and identified based on the aggregated data. For example, the database may be generally searched to find all security events of a particular event type occurring within a geographic region, such as Europe, during the previous seven days. Alternatively, the database may be searched more specifically to identify the most common security event encountered by network owners located in the United States who sell computer equipment and use their web site for e-commerce. Still another search could identify security events having the greatest percentage increase in frequency of occurrence during the past 24 hours. Those skilled in the art will readily see that many types of demographic analysis are possible, limited only by the amount of information accumulated in the database.

The entries in Common Signature database 430 are also linked to Vulnerability database 440 and Product database 450. Vulnerability database 440 contains a listing of validated security threats, such as software flaws that are susceptible to attack via network. Product database 450 contains a listing of specific products that exhibit a particular vulnerability. For example, Vulnerability database 440 may contain an entry describing a particular way that SNMP software may be exploited. This entry would describe the flaw in detail, including how the flaw may be exploited and what type of harm could result from an attack targeting this flaw. Product database 450 would then have one or more entries containing vendor, product, and version information for products that are vulnerable due to this flaw in SNMP. The entry in Product database 450 would also provide additional details such as, for example, how to patch the flaw, other security measures that a network operator could implement, and how to repair damage caused when the flaw is exploited.

While Common Signature database 430, Vulnerability database 440, and Product database 450 are depicted as individual databases, the functions of all of these databases may be combined in a single database such as Threat database 460. Combining these databases into a single structure could lead to performance improvements, such as simplifying the process of identifying certain types of validated threats.

As will be understood by those familiar with the art, the invention may be embodied in other specific forms without departing from the spirit or essential characteristics thereof. Likewise, the particular naming and division of the modules, features, attributes, methodologies and other aspects are not mandatory or significant, and the mechanisms that implement the invention or its features may have different names, divisions and/or formats. Furthermore, as will be apparent to one of ordinary skill in the relevant art, the modules, features, attributes, methodologies and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming.

We claim:

1. A computer implemented method for the early detection of validated security threats, the method comprising:
obtaining security event data initially gathered by a plurality of security devices;
converting the security event data into common, vendor-independent security event types;
performing a security event analysis on the security event data to identify validated security threats; and
preparing an alert based on the identified validated security threats.

2. The method of claim 1, wherein the security event data comprises a listing of individual security events in a vendor specific format.

3. The method of claim 1, wherein the security event data comprises a listing of individual security events, wherein each security event comprises the source IP address of the event, the source port of the event, the destination IP address of the event, the destination port of the event, the protocol associated with the event, the event name, event specific packet data, and a timestamp for the event.

4. The method of claim 1, wherein obtaining the security event data comprises extracting at least one security event from an output file of a security device.

5. The method of claim 1, wherein obtaining the security event data comprises receiving the security event data from another processing unit via a network.

6. The method of claim 1, wherein obtaining the security event data comprises receiving a data stream of security events from a security device.

7. The method of claim 1, wherein at least one security device comprises an intrusion detection system.

8. The method of claim 1, wherein at least one security device comprises a security firewall.

9. The method of claim 1, wherein at least one security device source comprises a computer antivirus program.

10. The method of claim 1, wherein at least one security device source comprises a honeypot.

11. The method of claim 1, wherein performing a security event analysis comprises comparing security events to a list of validated security threats.

12. The method of claim 1, wherein performing a security event analysis comprises identifying a linked series of security events.

13. The method of claim 12, wherein identifying the linked series of security events comprises detecting a pattern of security events independent of the sequence of occurrence of the security events.

14. The method of claim 12, wherein identifying the linked series of security events comprises detecting a series of security events occurring in a specific sequence.

15. The method of claim 1, wherein performing a security event analysis comprises:
determining a number of occurrences of a security event type within a time period; and
determining a variance in the number of occurrences relative to a baseline value.

16. The method of claim 1, wherein obtaining the security event data further comprises associating the security event data with demographic and geographic information about the network providing the security event data.

17. The method of claim 1, further comprising determining identification information for originating parties of at least one security event within the security event data.

18. The method of claim 17, wherein determining identification information for the originating parties comprises receiving the identification information from another processing unit via a network.

19. The method of claim 1, wherein preparing an alert comprises generating a report based on an identified validated security threat.

20. The method of claim 1, wherein preparing an alert comprises maintenance of a Threat Level.

21. The method of claim 1, further comprising aggregating the obtained security event data with other previously obtained security event data prior to the step of performing a security event analysis.

22. The method of claim 1, further comprising automatically notifying an originating party about participation of the originating party in a security event.

23. A computer implemented method for analysis of network security events, the method comprising:
obtaining security event data that was initially gathered by at least one security device;
converting the security event data into common, vendor-independent security event types;
analyzing the security event data to determine a number of occurrences for at least one security event type and to identify linked series of security events within the security event data;
determining identification information for originating parties of at least one security event; and
preparing an alert describing results from the analyzing step for at least one security event.

24. The method of claim 23, wherein the security event data comprises a listing of individual security events in vendor specific format.

25. The method of claim 23, wherein the security event data comprises a listing of individual security events, wherein each security event comprises the source IP address of the event, the source port of the event, the destination IP address of the event, the destination port of the event, the protocol associated with the event, the event name, event specific packet data, and a timestamp for the event.

26. The method of claim 23, wherein obtaining the security event data comprises extracting at least one security event from an output file of a security device.

27. The method of claim 23, wherein obtaining the security event data comprises receiving the security event data from another processing unit via a network.

28. The method of claim 23, wherein obtaining the security event data comprises receiving a data stream of security events from a security device.

29. The method of claim 23, wherein the security device comprises an intrusion detection system.

30. The method of claim 23, wherein the security device comprises a security firewall.

31. The method of claim 23, wherein the security device source comprises a computer antivirus program.

32. The method of claim 23, wherein the security device source comprises honeypot.

33. The method of claim 23, wherein identifying the linked series of security events comprises detecting a pattern of security events independent of the sequence of occurrence of the security events.

34. The method of claim 23, wherein identifying the linked series of security events comprises detecting a series of security events occurring in a specific sequence.

35. The method of claim 23, wherein analyzing the security event data further comprises determining a variance in the number of occurrences for the at least one security event type relative to a baseline value.

36. The method of claim 23, wherein obtaining the security event data further comprises associating the security event data with demographic and geographic information about the network providing the security event data.

37. The method of claim 23, further comprising automatically notifying an originating party about participation of the originating party in a security event.

38. The method of claim 23, wherein determining identification information for the originating parties comprises receiving the identification information from another processing unit via a network.

39. The method of claim 23, wherein preparing an alert comprises generating a report based on an identified validated security threat.

40. The method of claim 23, wherein preparing an alert comprises maintenance of a Threat Level.

41. The method of claim 23, further comprising aggregating the obtained security event data with other previously obtained security event data prior to the step of performing a security event analysis.

42. A computer implemented method for identifying validated network security threats, the method comprising:
obtaining security event data that was initially gathered by at least one security device;
performing a security event analysis on the security event data to identify validated security threats; and
preparing an alert based on the identified validated security threats.

43. The method of claim 42, wherein the security event data comprises a listing of individual security events in vendor specific format.

44. The method of claim 42, wherein the security event data comprises a listing of individual security events, wherein each security event comprises the source IP address of the event, the source port of the event, the destination IP address of the event, the destination port of the event, the protocol associated with the event, the event name, event specific packet data, and a timestamp for the event.

45. The method of claim 42, wherein obtaining the security event data comprises extracting at least one security event from an output file of a security device.

46. The method of claim 42, wherein obtaining the security event data comprises receiving the security event data from another processing unit via a network.

47. The method of claim 42, wherein obtaining the security event data comprises receiving a data stream of security events from a security device.

48. The method of claim 42, wherein the security device comprises an intrusion detection system.

49. The method of claim 42, wherein the security device comprises a security firewall.

50. The method of claim 42, wherein the security device comprises a computer antivirus program.

51. The method of claim 42, wherein the security device comprises a honeypot.

52. The method of claim 42, wherein performing a security event analysis comprises comparing the security event data to a list of validated security threats.

53. The method of claim 42, wherein performing a security event analysis comprises identifying a linked series of security events.

54. The method of claim 53, wherein identifying the linked series of security events comprises detecting a pattern of security events independent of the sequence of occurrence of the security events.

55. The method of claim 53, wherein identifying the linked series of security events comprises detecting a series of security events occurring in a specific sequence.

56. The method of claim 42, wherein performing a security event analysis comprises:
determining a number of occurrences of a security event type within a time period; and
determining a variance in the number of occurrences relative to a baseline value.

57. The method of claim 42, wherein obtaining the security event data further comprises associating the security event data with demographic and geographic information about the network providing the security event data.

58. The method of claim 42, further comprising determining identification information for originating parties of at least one of the security events.

59. The method of claim 58, wherein determining identification information for the originating parties comprises receiving the identification information from another processing unit via a network.

60. The method of claim 42, wherein preparing an alert comprises generating a report based on an identified validated security threat.

61. The method of claim 42, further comprising automatically notifying an originating party about participation of the originating party in a security event.

62. The method of claim 42, further comprising aggregating the obtained security event data with other previously obtained security event data, prior to the step of performing a security event analysis.

63. The method of claim 42, wherein obtaining the security event data comprises receiving a summary of security event data that was previously analyzed by another processing unit.

64. The method of claim 42, wherein preparing an alert comprises maintenance of a Threat Level.

65. A computer implemented method for identifying network security incidents, the method comprising:
obtaining security event data that was initially gathered by at least one security device;
analyzing the security event data to determine a frequency of occurrence for at least one security event type and to identify linked series of security events within the security event data;
comparing the analyzed security event data with a listing of validated security threats; and
preparing an alert based on the results of the analyzing and comparing steps.

66. A computer system for the early detection of validated security threats, the computer system comprising:
a software portion configured for obtaining security event data initially gathered by a plurality of security devices;
a software portion configured for converting the security event data into common, vendor-independent security event types;
a software portion configured for performing a security event analysis on the security event data to identify validated security threats; and
a software portion configured for preparing an alert based on the identified validated security threats.

67. The computer system of claim 66, wherein the security event data comprises a listing of individual security events in a vendor specific format.

68. The computer system of claim 66, wherein the software portion configured for performing a security event analysis comprises a software portion configured for identifying a linked series of security events.

69. The computer system of claim 68, wherein the software portion configured for identifying the linked series of security events comprises a software portion configured for detecting a pattern of security events independent of the sequence of occurrence of the security events.

69. The computer system of claim 68, wherein the software portion configured for identifying the linked series of security events comprises a software portion configured for detecting a series of security events occurring in a specific sequence.

70. The computer system of claim 66, wherein the software portion configured for performing a security event analysis comprises:
a software portion configured for determining a number of occurrences of a security event type within a time period; and
a software portion configured for determining a variance in the number of occurrences relative to a baseline value.

71. The computer system of claim 66, wherein the software portion configured for obtaining the security event data further comprises a software portion configured for associating the security event data with demographic and geographic information about the network providing the security event data.

72. The computer system of claim 66, further comprising a software portion configured for determining identification information for originating parties of at least one security event within the security event data.

73. The computer system of claim 66, wherein the software portion configured for preparing an alert comprises a software portion configured for generating a report based on an identified validated security threat.

74. The computer system of claim 66, wherein the software portion configured for preparing an alert comprises a software portion configured for maintenance of a Threat Level.

75. A computer system for analysis of network security events, the computer system comprising:
a software portion configured for obtaining security event data that was initially gathered by at least one security device;
a software portion configured for analyzing the security event data to determine a number of occurrences for at least one security event type and to identify linked series of security events within the security event data;
a software portion configured for determining identification information for originating parties of at least one security event; and
a software portion configured for preparing an alert describing results from the analyzing step for at least one security event.

76. The computer system of claim 75, wherein the software portion configured for obtaining the security event data comprises a software portion configured for receiving a data stream of security events from a security device.

77. The computer system of claim 75, wherein the software portion configured for identifying the linked series of security events comprises a software portion configured for detecting a pattern of security events independent of the sequence of occurrence of the security events.

78. The computer system of claim 75, wherein the software portion configured for identifying the linked series of security events comprises a software portion configured for detecting a series of security events occurring in a specific sequence.

79. The computer system of claim 75, wherein the software portion configured for analyzing the security event data further comprises a software portion configured for determining a variance in the number of occurrences of the at least one security event type relative to a baseline value.

80. The computer system of claim 75, wherein the software portion configured for obtaining the security event data further comprises a software portion configured for associating the security event data with demographic and geographic information about the network providing the security event data.

81. The computer system of claim 75, wherein the software portion configured for preparing an alert comprises a software portion configured for generating a report based on an identified validated security threat.

82. The computer system of claim 75, wherein the software portion configured for preparing an alert comprises a software portion configured for maintenance of a Threat Level.

83. The computer system of claim 75, further comprising a software portion configured for aggregating the obtained security event data with other previously obtained security event data prior to the step of performing a security event analysis.

84. A computer system for the early detection of validated security threats, the computer system comprising:
means for obtaining security event data initially gathered by a plurality of security devices;
means for converting the security event data into common, vendor-independent security event types;
means for performing a security event analysis on the security event data to identify validated security threats; and
means for preparing an alert based on the identified validated security threats.

85. The computer system of claim 84, wherein the security event data comprises a listing of individual security events in a vendor specific format.

86. The computer system of claim 84, wherein the means for performing a security event analysis comprises means for identifying a linked series of security events.

87. The computer system of claim 86, wherein the means for identifying the linked series of security events comprises means for detecting a pattern of security events independent of the sequence of occurrence of the security events.

88. The computer system of claim 86, wherein the means for identifying the linked series of security events comprises means for detecting a series of security events occurring in a specific sequence.

89. The computer system of claim 84, wherein the means for performing a security event analysis comprises:
means for determining a number of occurrences of a security event type within a time period; and
means for determining a variance in the number of occurrences relative to a baseline value.

90. The computer system of claim 84, wherein the means for obtaining the security event data further comprises means for associating the security event data with demographic and geographic information about the network providing the security event data.

91. The computer system of claim 84, further comprising means for determining identification information for originating parties of at least one security event within the security event data.

92. The computer system of claim 84, wherein the means for preparing an alert comprises means for generating a report based on an identified validated security threat.

93. The computer system of claim 84, wherein the means for preparing an alert comprises means for maintenance of a Threat Level.

94. A computer system for analysis of network security events, the computer system comprising:
means for obtaining security event data that was initially gathered by at least one security device;
means for analyzing the security event data to determine a number of occurrences for at least one security event type and to identify linked series of security events within the security event data;
means for determining identification information for originating parties of at least one security event; and
means for preparing an alert describing results from the analyzing step for at least one security event.

95. The computer system of claim 94, wherein the means for obtaining the security event data comprises means for receiving a data stream of security events from a security device.

96. The computer system of claim 94, wherein the means for identifying the linked series of security events comprises means for detecting a pattern of security events independent of the sequence of occurrence of the security events.

97. The computer system of claim 94, wherein the means for identifying the linked series of security events comprises means for detecting a series of security events occurring in a specific sequence.

98. The computer system of claim 94, wherein the means for analyzing the security event data further comprises means for determining a variance in the number of occurrences of the at least one security event type relative to a baseline value.

99. The computer system of claim 94, wherein the means for obtaining the security event data further comprises means for associating the security event data with demographic and geographic information about the network providing the security event data.

100. The computer system of claim 94, wherein the means for preparing an alert comprises means for generating a report based on an identified validated security threat.

101. The computer system of claim 94, wherein the means for preparing an alert comprises means for maintenance of a Threat Level.

102. The computer system of claim 94, further comprising means for aggregating the obtained security event data with other previously obtained security event data prior to the step of performing a security event analysis.

103. A computer program product for the early detection of validated security threats, the computer program product comprising:
program code for obtaining security event data initially gathered by a plurality of security devices;
program code for converting the security event data into common, vendor-independent security event types;
program code for performing a security event analysis on the security event data to identify validated security threats; and
program code for preparing an alert based on the identified validated security threats.

104. The computer program product of claim 103, wherein the security event data comprises a listing of individual security events in a vendor specific format.

105. The computer program product of claim 103, wherein the program code for performing a security event analysis comprises program code for identifying a linked series of security events.

106. The computer program product of claim 105, wherein the program code for identifying the linked series of security events comprises program code for detecting a pattern of security events independent of the sequence of occurrence of the security events.

107. The computer program product of claim 105, wherein the program code for identifying the linked series of security events comprises program code for detecting a series of security events occurring in a specific sequence.

108. The computer program product of claim 103, wherein the program code for performing a security event analysis comprises:
program code for determining a number of occurrences of a security event type within a time period; and
program code for determining a variance in the number of occurrences relative to a baseline value.

109. The computer program product of claim 103, wherein the program code for obtaining the security event data further comprises program code for associating the security event data with demographic and geographic information about the network providing the security event data.

110. The computer program product of claim 103, further comprising program code for determining identification information for originating parties of at least one security event within the security event data.

111. The computer program product of claim 103, wherein the program code for preparing an alert comprises program code for generating a report based on an identified validated security threat.

112. The computer program product of claim 103, wherein the program code for preparing an alert comprises program code for maintenance of a Threat Level.

113. A computer program product for analysis of network security events, the computer program product comprising:
program code for obtaining security event data that was initially gathered by at least one security device;
program code for analyzing the security event data to determine a number of occurrences for at least one security event type and to identify linked series of security events within the security event data;
program code for determining identification information for originating parties of at least one security event; and
program code for preparing an alert describing results from the analyzing step for at least one security event.

114. The computer program product of claim 113, wherein the program code for obtaining the security event data comprises program code for receiving a data stream of security events from a security device.

115. The computer program product of claim 113, wherein the program code for identifying the linked series of security events comprises program code for detecting a pattern of security events independent of the sequence of occurrence of the security events.

116. The computer program product of claim 113, wherein the program code for identifying the linked series of security events comprises program code for detecting a series of security events occurring in a specific sequence.

117. The computer program product of claim 113, wherein the program code for analyzing the security event data further comprises program code for determining a variance in the number of occurrences of the at least one security event type relative to a baseline value.

118. The computer program product of claim 113, wherein the program code for obtaining the security event data further comprises program code for associating the security event data with demographic and geographic information about the network providing the security event data.

119. The computer program product of claim 113, wherein the program code for preparing an alert comprises program code for generating a report based on an identified validated security threat.

120. The computer program product of claim 113, wherein the program code for preparing an alert comprises program code for maintenance of a Threat Level.

121. The computer program product of claim 113, further comprising program code for aggregating the obtained security event data with other previously obtained security event data prior to the step of performing a security event analysis.
